(19) United States
(12) Patent Application Publication
(10) Pub. No.: US 2009/0263211 A1
(43) Pub. Date: Oct. 22, 2009

(54) Method for Binding a Bundle of Loose Leaves or the Like and Binding Element, End Leaf or Cover Applied Thereby

(76) Inventor: Guido Peleman, Antwerpen (BE)

Correspondence Address: BACON & THOMAS, PLLC, 625 SLATERS LANE, FOURTH FLOOR, ALEXANDRIA, VA, 22314-1176, US

(21) Appl. No.: 11/992,775

(22) PCT Filed: Oct. 2, 2006
(86) PCT No.: PCT/IB2006/002737

§ 371 Date: Mar. 28, 2008

(30) Foreign Application Priority Data
Oct. 3, 2005 (BE) 2005/0477
Oct. 6, 2005 (BE) 2005/0489
Oct. 17, 2005 (BE) 2005/0508
Apr. 6, 2006 (BE) 2006/0216

(51) Int. Cl. B42C 11/00

(52) U.S. Cl. 412/4

(57) ABSTRACT

Method for binding a bundle of loose leaves or the like in a cover (4) with a back (5), characterised in that it mainly comprises the following steps:—binding a free edge of the above-mentioned bundle of loose leaves (1);—providing the bundle of leaves (1) with its bound edge in the back (5) of the cover (4) and fixing this bundle (1) in the cover (4).

The present invention concerns a method for binding a bundle of loose leaves or the like.

In particular, the present invention concerns a method for binding a bundle of loose leaves or the like in a cover with a back.

A method for binding a bundle of loose leaves in a cover with a back is already known, whereby the end leaves of this bundle are provided on the respective outsides and are provided with a layer of glue over their entire surface, and whereby the leaves of this bundle are subsequently joined together on one side edge by means of gluing or stitching, after which this bundle of leaves is provided with the glued or stitched edge in the back of the cover and the cover is subsequently folded up, so that the end leaves are glued to the inside of the cover by the above-mentioned layer of glue.

A disadvantage of such a known method is that, in order to join the bundle of loose leaves together by means of gluing or stitching and to provide a layer of glue on the inside of the cover, a manufacturing device is always required which is usually relatively expensive, as a result of which such a method is not interesting for sporadic and/or private use.

The present invention aims to remedy the above-mentioned and other disadvantages.

To this end, the present invention concerns a method for binding a bundle of loose leaves or the like in a cover with a back, characterised in that it mainly comprises the following steps:
binding a free edge of the above-mentioned bundle of loose leaves;
providing a strip of glue on the above-mentioned bundle of loose leaves near the above-mentioned free edge of the bundle of leaves and at a distance of this free edge which is almost equal to or somewhat larger than the depth of the back of the cover;
providing the bundle of leaves with its bound edge in the back of the cover and fixing this bundle in the cover by means of the above-mentioned strip of glue.

The free edge of the bundle of loose leaves can be bound in many ways, for example by means of stapling, stitching, cold gluing, punching with plastic or metal rings or other binding techniques.

The layer of glue has been provided, either on the end leaves which are bound together with the bundle of loose leaves or on a binding element which has been previously provided round the edge of the bundle to be bound.

Such a method is advantageous in that a bundle of loose leaves can be joined in a very simple and fast manner, for example by means of stapling, and in that this bundle can then be fixed in a cover without having to make use of expensive manufacturing devices.

The invention also concerns an end leaf which can be bound together with a bundle of loose leaves in a method according to the invention, which end leaf is provided with a strip of glue which has preferably been provided beforehand near a free edge thereof.

Finally, the invention also concerns a binding element which can be applied in a method according to the invention, whereby this binding element consists of a binding element which has been folded or can be folded in a U- or V-shape, which is provided with at least one strip of glue on its outside and which is designed to be provided round the free edge of the bundle of leaves to be bound before the latter is provided in the cover.

In order to better explain the characteristics of the invention, the following preferred method according to the invention for binding a bundle of loose leaves or the like is described, as well as an end leaf, cover or binding element applied thereby, with reference to the accompanying drawings, in which:

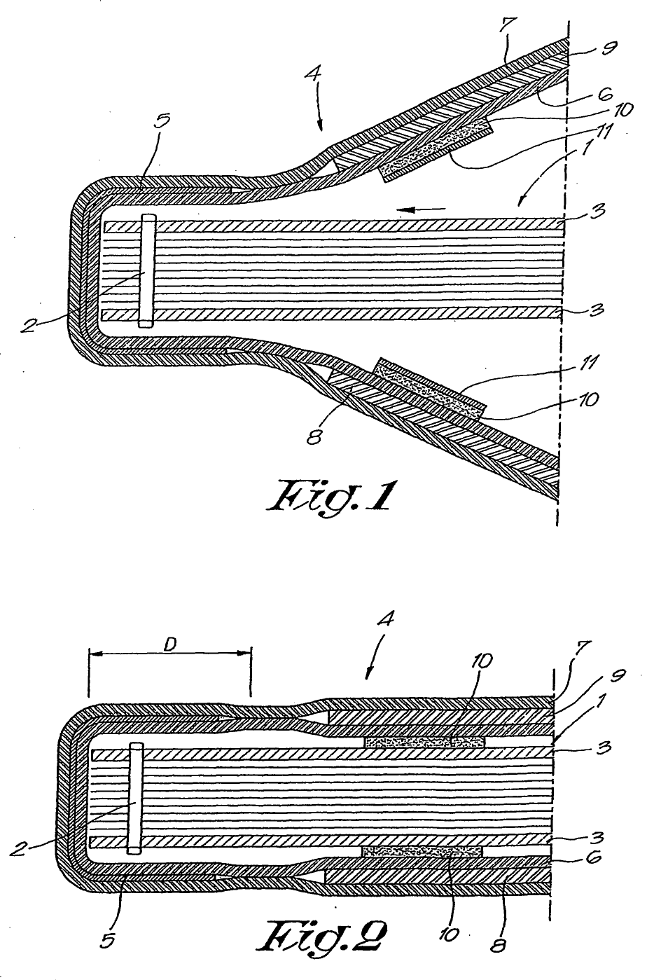

FIGS. 1 and 2 represent a method for binding a bundle of loose leaves;

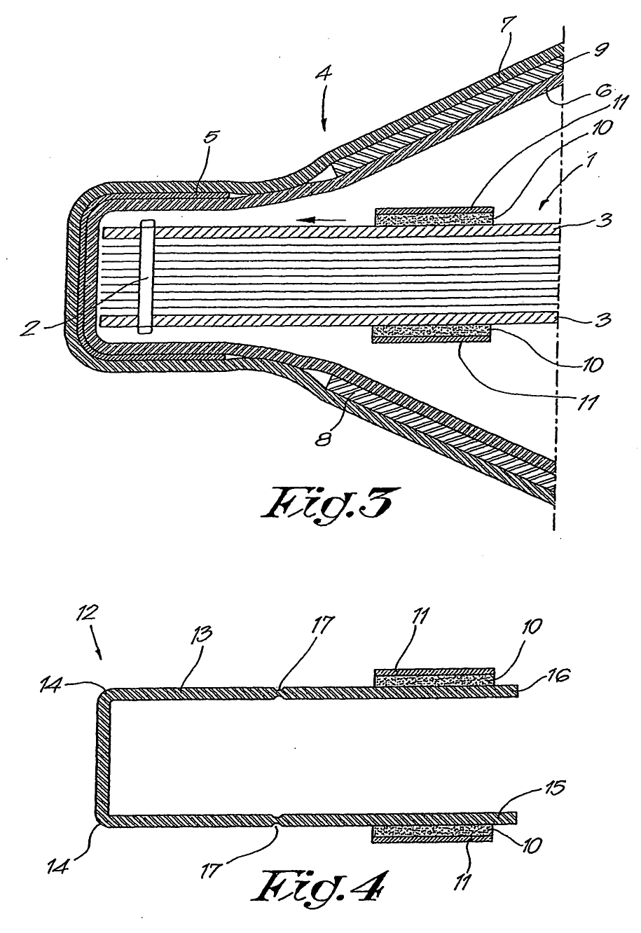

FIG. 3 represents a method according to the invention;

FIG. 4 represents a binding element which can be applied in a method according to the invention;

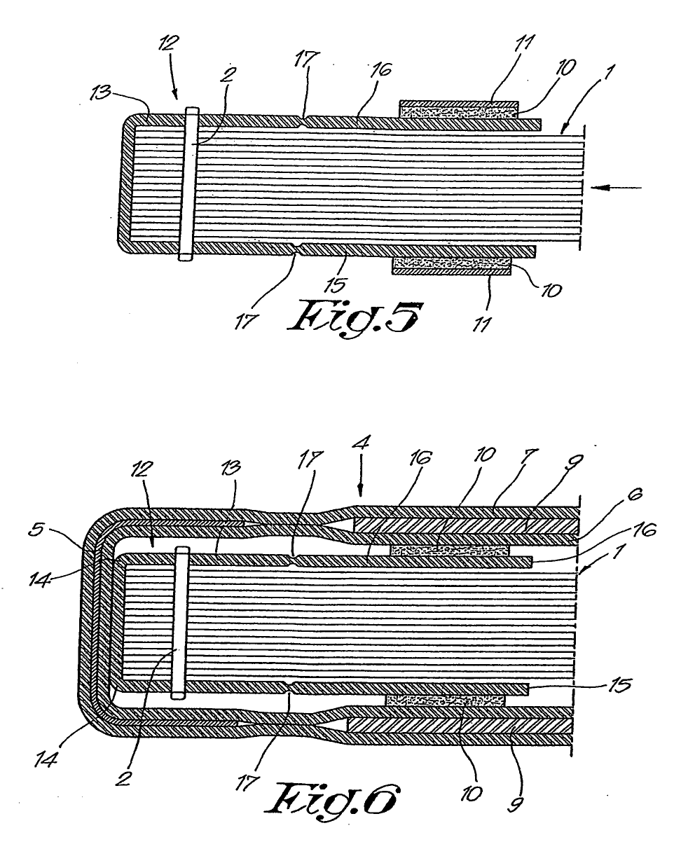

FIGS. 5 and 6 represent different steps that are successively followed when binding a bundle of loose leaves with a binding element according to FIG. 4;

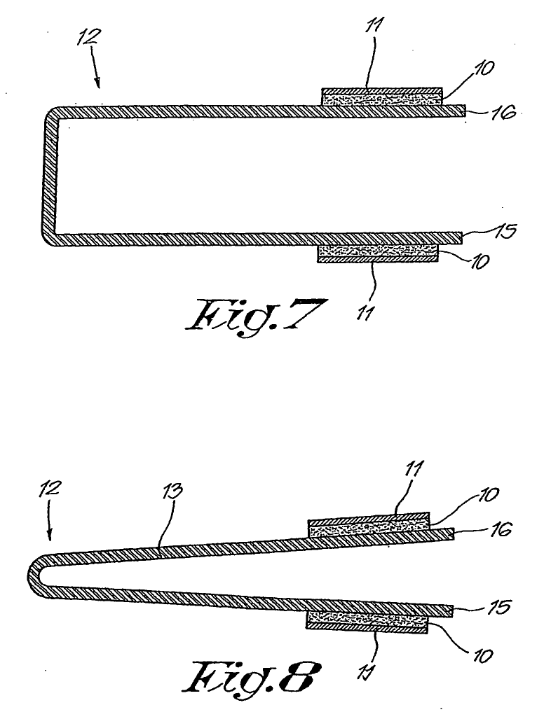

FIGS. 7 and 8 represent variants of a binding element according to FIG. 4;

FIG. 9 represents an end leaf for applying a method according to FIG. 3;

FIG. 10 represents the us e of an end leaf according to FIG. 9;

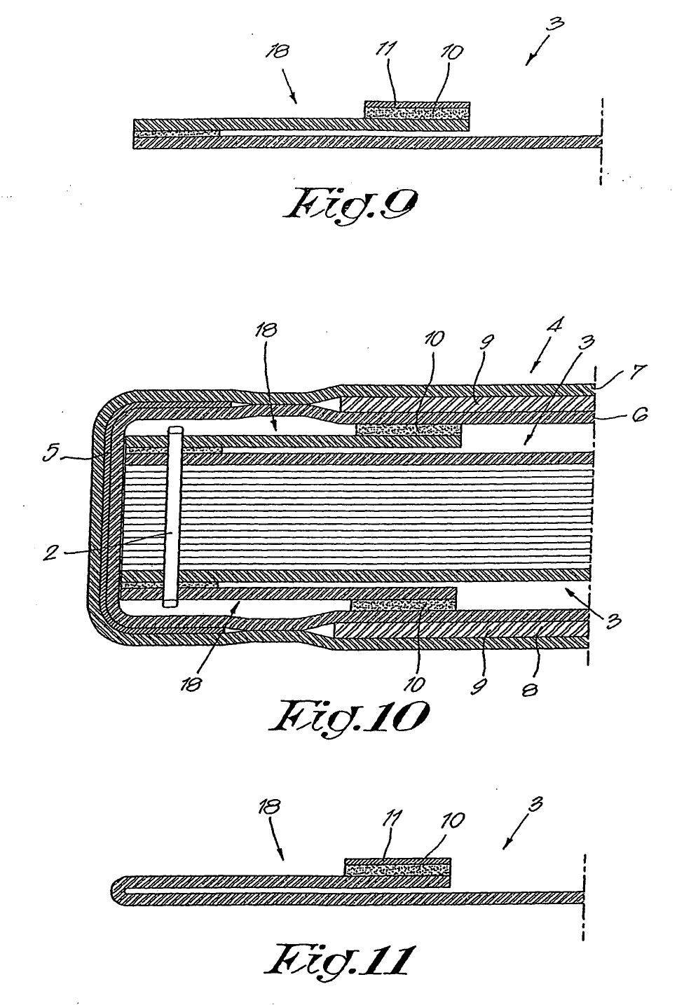

FIG. 11 represents a variant according to FIG. 9.

FIGS. 12 and 13, 14 and 15 respectively, represent a variant of a method according to FIGS. 1 and 2;

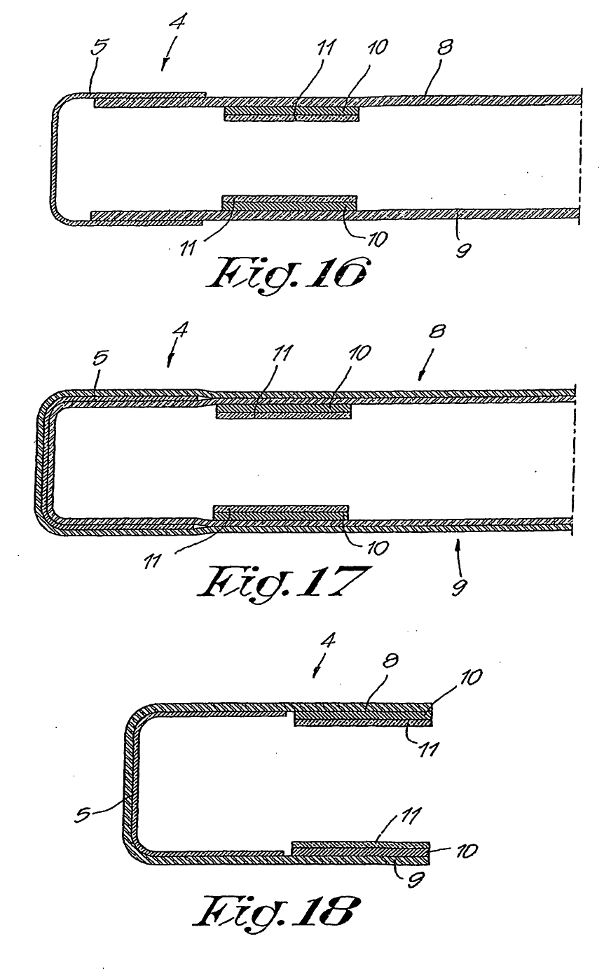

FIGS. 16 to 18 represent variants of a cover according to FIG. 12.

As is represented in FIGS. 1 and 2, a free edge of a bundle of loose leaves 1 is bound first, for example as this free edge is stapled with one or several staples 2.

It goes without saying that the present invention is not restricted to binding by means of stapling, but that also other binding techniques can be applied such as stitching, cold gluing, hot gluing, punching with plastic or metal rings or the like.

Each time we hereafter talk about stapling, also other binding techniques can be applied.

In this case, but not necessarily, use can be made of end leaves 3 when binding, provided on the outsides of the above-mentioned bundle of leaves 1 and which are made of a relatively rigid, either or not flexible material which can be stapled, such as for example cardboard, plastic or paper. These materials may be single-layered, multilayered, coated or laminated.

Next, the above-mentioned bundle of leaves 1 is provided with its stapled edge in a cover 4 which in this case is built as a U-shaped back 5 which is preferably made of metal, but which can also be made of any other, preferably hard material, such as for example ceramics, a rigid plastic, or the like.

It is clear that the above-mentioned back 5 of the cover 4 can also be made of any flexible material whatsoever and that this back 5 must not necessarily be U-shaped either.

Against the inside and outside of this back 5 is in this case provided a coating 6, 7 respectively.

The cover 4 is also provided with two preferably rigid leaves 8 and 9 which are joined in a folding manner to the above-mentioned back 5 on either side as they extend between the above-mentioned coatings 6 and 7 as well.

According to the invention, the above-mentioned leaves 8 and 9 can be made of plastic or in the shape of an either or not coated piece of cardboard or paper. These materials can be single-layered, multi-layered, coated or laminated.

On the insides of the above-mentioned leaves 8 and 9 is provided a strip of glue 10 near the back 5 of the cover 4 which has been provided beforehand in this case and which can be covered by means of a removable foil 11.

In this case, the strip of glue 10 is realised with a self-adhesive glue, but it is not excluded according to the invention that this strip of glue 10 is realised by means of a glue which can be thermally activated, i.e. what is called a melting glue, or by means of a cold glue, which might be useful should the method be applied on an industrial scale.

Every time glue is mentioned further in this description, any type of glue is meant by it.

In order to fix the stapled bundle of leaves 1 in the cover 4 in a final step of the method according to the invention, the cover 4 is folded up, after the above-mentioned foils 11 have been removed, such that the bundle 1 is glued with its outermost end leaves 8 and 9 onto the inside of the cover 4 by the strips of glue 10.

Since such a method according to the invention can merely use a simple, ordinary stapler instead of expensive and complex manufacturing machines, such a method is economical and is particularly fit for small-scale or private applications.

It is clear, however, that the method according to the invention is not restricted to small-scale applications and that it is particularly fit for large-scale, industrial applications, whereby use can be made of other binding techniques than stapling, should that be necessary.

The term “strip of glue” should hereby be regarded in the broadest sense and it is not restricted to a narrow strip; on the contrary, it can also be realised as a surface of glue which extends over the entire or practically the entire surface of the leaves 8 and/or 9.

FIG. 3 represents the method according to the invention, whereby the above-mentioned strips of glue 10 have been provided beforehand on the above-mentioned end leaves 3 which have been bound together, and in this case stapled together with the bundle 1.

The strips of glue 10 are hereby preferably provided near and parallel to the free edge of the end leaves 3, in particular at a distance which is almost equal to or somewhat larger than the depth D of the back 5 of the cover 4.

In this case as well, the strips of glue 10 can be realised as surfaces of glue, however, extending over the entire or practically the entire surface of the end leaves 3.

It goes without saying that the end leaves 3 may have practically the same format as the bundle of leaves to be bound, in which case the cover 4 does not have to be provided with an inner coating 6 or what are called “mirror leaves” glued onto the insides of the leaves 8 and 9 of the cover 4.

It is not excluded, however, for the end leaves 3 to be made smaller than the bundle of leaves to be bound.

FIG. 4 represents a binding element 12 according to the invention which in this case mainly consists of a folding element 13 which in this case, but not necessarily, is made of a layer of cardboard and which is also provided with folding lines 14.

The binding element 12 is also provided with two strips of material 15 and 16 which in this case are part of this binding element 12, but which can also be made in the shape of separate strips of material which are connected to the free ends of the folding binding element 12 in a folding manner at folding or perforation lines 17.

On each of the above-mentioned strips of material 15 and 16 is in this case provided a strip of glue 10 on the outside of the folding binding element 12 which extends entirely or partly over a respective strip of material 15 or 16 and which, if required, can be covered with a foil 11.

It is clear that, according to the invention, the binding element 12 must not necessarily be preformed, but that one can also start with a flat element which is provided with one or several strips of glue 10 on one side and which is folded in the required U-shape before use, as is represented in FIG. 4.

It is also clear that the above-mentioned strips of material 15 and 16 may have any dimensions whatsoever and that they may be smaller than the leaves to be bound or almost equally large as this bundle of leaves.

The method for binding a bundle of loose leaves 1 or the like by means of a binding element 12 according to the invention is very simple and is represented in FIGS. 5 and 6.

As is represented in FIG. 5, the above-mentioned binding element 12 folded in a U-shape is provided round a free edge of a bundle of loose leaves 1, and this free edge of the above-mentioned bundle of loose leaves 1 and the binding element 12 provided around it are joined together by means of one or several staples 2 in this case.

As is represented in FIG. 6, the bundle of leaves 1 is subsequently provided with its bound, stapled edge in the U-shaped back 5 of a cover 4 and this bundle of leaves 1 is fixed in this cover 4, to which end, in the given example, the above-mentioned strips of material 15 and 16, after the above-mentioned foils 11 have been removed, are glued with their strips of glue 10 onto the respective insides of the cover 4.

In the given example, the binding element 12 is made of cardboard, but it is clear that this binding element 12 can be made of many other materials, such as among others paper, which can preferably be stapled and which can preferably be folded as well so as to form a U-shaped element or which have already been made according to such a U-shape.

The example of binding element 12 represented in FIG. 4 is provided with two strips of material 15 and 16, but it is clear that the presence of such strips of material 15 and 16 is not required according to the invention, and that the above-mentioned bundle of leaves 1 can also be fixed in the cover 4, and particularly in the back 5 of this cover 4, by means of a strip of glue which is provided on the back of the U-shaped part of the binding element 12.

Nor is it excluded that merely one strip of material 15 or 16 is provided, onto which is provided a strip of glue 10, either or not combined with the presence of a strip of glue on the back of the binding element 12.

The invention is not restricted to one embodiment of binding element 12 whereby the strip of glue 10 merely extends over a part of the respective strip of material 15 or 16, but the strips of glue 10 can also extend over the entire strips of material 15 or 16, and they may even be provided on the entire surface of the binding element 12.

FIG. 7 represents another embodiment of a binding element 12 according to the invention which is made in the shape of a pre-folded ü-shaped mould made of a flexible material, whereby the strips of material 15 and 16 are integrally part of the binding element 12 and whereby, thanks to the flexibility of the selected material, no folding or perforation lines must be provided.

FIG. 8 represents yet another possible embodiment of a binding element 12 according to the invention, which in this case is made V-shaped instead of U-shaped and which is more appropriate for the binding of thin bundles of leaves 1.

It is clear that, in all the embodiments of binding element 12 which are represented in FIGS. 4 to 8, the strip of glue 10 can only extend over a restricted width, or it can be realised in the shape of a surface of glue which extends over the entire or almost the entire surface of a respective strip of material 15 or 16.

FIG. 9 represents a variant of an end leaf 3 according to the invention whereby this end leaf 3 is provided with a fixing strip 18 on one side edge, for example made of paper, which fixing strip 18 is fixed to the edge concerned of the end leaf 3 by means of gluing in this case.

According to the invention, only the side edge of the fixing strip 18 to be bound is hereby fixed to the end leaf 3.

On the part of the fixing strip 18 which is not glued to the end leaf 3, on the side turned away from the end leaf 3, is provided a strip of glue 10 at a distance from the above-mentioned side edge of the end leaf 3 to be bound according to the invention.

On the above-mentioned strip of glue 10 is preferably provided a removable foil 11.

FIG. 10 represents the use of such an end leaf 3, whereby, in this case, on either side of the bundle of leaves 1 to be bound, is provided an end leaf 3 according to FIG. 9.

The end leaves 3 are hereby positioned such that their above-mentioned fixing strip 18 is situated on the side edge of the bundle of leaves 1 to be bound, and such that these fixing strips 18 are turned outward, away from the bundle of leaves 1.

The bundle of leaves 1 is preferably joined together with the end leaves 3 by providing staples 2 through the parts of the fixing strips 18 that are glued to the end leaves 3.

After the bundle of leaves 1 and the end leaves 3 have been bound together, for example by means of stapling, the foils 11 are removed from the strips of glue 10 and the stapled bundle is provided in a cover 4 and glued to the inside of the cover 4 by means of said fixing strips 18.

As the part of the fixing strip 18 on which the above-mentioned strip of glue is provided is not fixed directly to the end leaf 3, the end leaves 3, when the cover 4 is opened, are not opened as well, which is the case with an end leaf as represented in FIG. 3.

An advantage of such an end leaf according to FIG. 9 is that the bundle of leaves always opens nicely and that the presence of the staples 2 is not visible, as the end leaves 3 are not glued to the cover 4.

Another advantage of such an end leaf 3 is that, between the cover 4 and the end leaf 3, the strip of glue 10 is not visible as the end leaf 3 own weight will not place a load on the strip of glue 10 when opening the cover 4.

FIG. 11 represents a variant of an end leaf 3 according to FIG. 9, whereby the fixing strip 18 is in this case fixed to the end leaf 3 as it is formed of a folded part of this end leaf 3.

Such an embodiment of an end leaf 3 is advantageous in that its production is very simple, as the fixing strip 18 must not be glued to the end leaf 3.

The use of such an end leaf according to FIG. 11 is analogous to that of the embodiment of FIG. 9.

It is clear that in the embodiments of end leaf 3 which are represented in FIGS. 9 to 11, the dimensions of the fixing strip 18 can be freely chosen, and that they may be just as large as the dimensions of the leaves to be bound and the cover, or that they may be smaller.

It is also clear that the strip of glue 10 must not necessarily extend over only a part of the fixing strip 18, but that it may also be provided over the entire or practically the entire surface of the fixing strip 18.

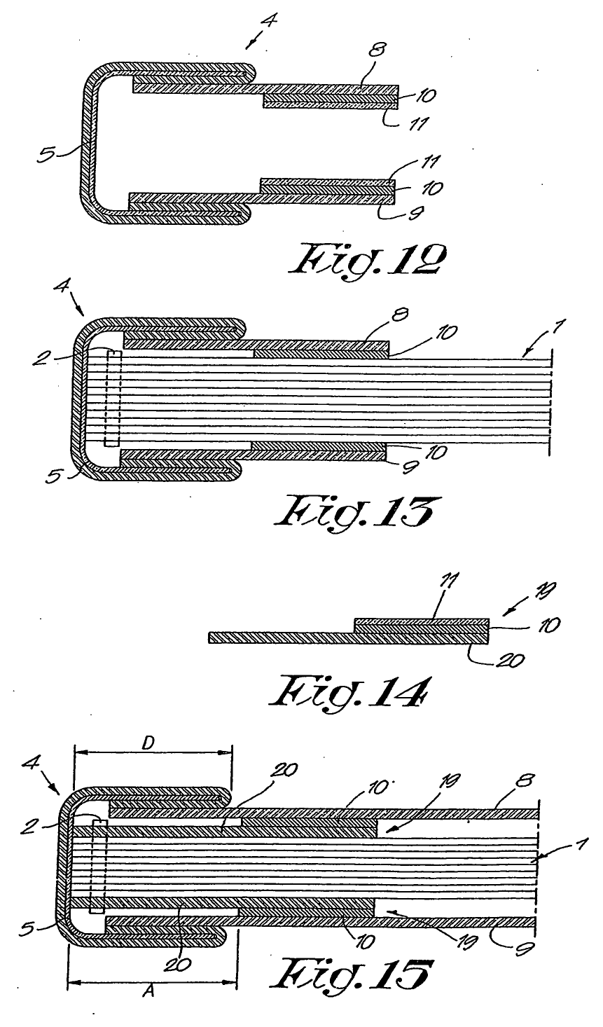

FIGS. 12 and 13 show a variant of a method according to the invention, whereby the above-mentioned leaves 8 and 9 of the cover 4 are in this case made in the shape of flexible strips of material, for example plastic, paper or the like, which are glued onto the respective inner sides of the legs of the U-shaped back 5.

Analogous to the cover which is represented in FIG. 1, a strip of glue 10 is provided on the insides of the respective leaves 8 and 9, near the back 5 of the cover 4, which in this case has been provided beforehand and which may be covered with a removable foil 11.

In order to bind a bundle of loose leaves 1, as is represented in FIG. 13, this bundle of leaves 1 is bound first, for example by means of staples 2, after which the stapled bundle of leaves 1 is provided in the back 5 of the cover 4 and is fixed there as the above-mentioned leaves 8 and 9 are glued onto the bundle of leaves 1 with their respective strips of glue 10.

In the given examples, the leaves 8 and 9 of the cover 4 are always connected to the legs of a U-shaped back 5 but, according to the invention, it is also possible for these leaves 8 and 9 to be connected to a flat back whereby, according to the invention, the above-mentioned strip of glue 10 is provided on each of the respective leaves 8 and 9.

FIGS. 14 and 15 represent another variant of a method according to the invention, whereby use is made of a binding element 19 according to FIG. 14 in this case.

The above-mentioned binding element 19 is in this case made in the form of a strip of material 20 which is preferably made of a material that can be stapled.

The above-mentioned strip of material 20 is provided with a strip of glue 10 on at least one side which, according to a preferred characteristic of the invention, is situated at a distance A from a side edge of the strip of material which is larger than the depth D of the U-shaped back 5 of the cover 4.

Naturally, the above-mentioned strip of material 20 can be made in any dimensions whatsoever and it may have the shape, for example, of a leave having the same dimensions as the bundle of leaves 1 to be bound.

The use of the binding element 19 according to FIG. 14 is represented in FIG. 15, whereby two such binding elements 19 are provided on each side of the bundle of leaves 1 to be bound in this case and are bound with the latter, for example by means of staples 2, such that these binding elements 19 with their respective strips of glue 10 are turned outward, away from the bundle of leaves 1 to be bound.

Next, the bound bundle of leaves is provided in the cover 4, which is in this case provided with leaves 8 and 9 made of a flexible material, for example plastic, paper or the like, and the respective strips of glue 10 are glued onto a respective leave 8 or 9.

FIG. 16 represents a variant of a cover 4 according to FIG. 12, whereby the back 5 is not provided with a coating in this case, and whereby leaves 8 and 9 are glued onto the respective insides of the legs of the back.

The leaves 8 and 9 are preferably made of a flexible material such as paper or plastic.

According to the invention, a strip of glue 10 is provided on each of the above-mentioned leaves 8 and 9 which is preferably, but not necessarily provided with a foil 11.

A method for binding a bundle of loose leaves in such a cover 4 is identical to the method which is represented in FIGS. 1 and 2, 12 and 13 respectively.

FIG. 17 represents another embodiment of a cover according to FIG. 12, whereby the leaves 8 and 9 are in this case formed of parts of the coating of the back 5 which extend past the far ends of the legs of the back 5, and which are glued onto each other.

It is clear that the leaves may also be formed by using only the outside coating of the back 5, as is represented in FIG. 18, or only the inside coating of the back 5.

The dimensions of the leaves 8 and 9 may be freely selected according to the invention and must not necessarily be equal to the dimensions of the bundle of leaves to be bound, but they may also be formed, as represented in FIG. 18, of a thin strip of material.

Analogous to what has been described above, the strip of glue 10 may be made of a self-adhesive glue in the case of the embodiments of FIGS. 16 to 18, but it is not excluded according to the invention for this strip of glue 10 to be made in the form of a glue which is thermally activated, also called a hot melt glue, or in the form of a cold glue.

The present invention is by no means limited to the method and end leaf 3, cover 4 or binding element 12 given as an example and represented in the figures; on the contrary, such a method according to the invention for binding a bundle of loose leaves 1 or the like, and an end leaf 3, cover 4 or binding element 12 applied thereby, can be made according to many variants while still remaining within the scope of the invention.

1. Method for binding a bundle of loose leaves in a cover with a back, comprising the steps:
binding a free edge of the above-mentioned bundle of loose leaves;
providing a strip of glue on the bundle of loose leaves near the free edge of the bundle of leaves and at a distance from the free edge which is almost equal to or somewhat larger than the depth of the back of the cover;
providing the bundle of leaves with its bound edge in the back of the cover and fixing the bundle in the cover by means of the strip of glue.

2. Method according to claim 1, wherein the gluing is carried out by means of a strip of glue which is provided on at least one of the end leaves of the bundle of leaves.

3. Method according to claim 1, wherein, before binding the free edge of the bundle of loose leaves, a binding element is provided round this free edge which has been folded over or in a U- or V-shape, and which is subsequently stapled together with the free edge of the bundle of leaves.

4. Method according to claim 1, wherein the gluing is done by means of a strip of glue which is provided on the outside of two strips of material which are connected to the folded binding element in a folding manner or which comprise part of it.

5. Method according to claim 4, wherein the strips of material are glued on to the leaves of the cover by means of the strips of glue.

6. Method according to claim 5, wherein the strips of material are glued on to the leaves of the cover, near the back of the cover.

7. Method according to claim 1, wherein, on the strip of glue there is provided a foil.

8. Binding element for carrying out the method of claim 1, comprising a binding element which is folded or is foldable in a U- or V-shape, and which is provided with at least one strip of glue on its outside.

9. Binding element according to claim 8, including a strip of material on one or both of its free ends which is connected to said binding element in a folding manner or which comprises part of the binding element, and wherein the strips of glue are provided on these strips of material.

10. Binding element according to claim 9, wherein the strips of material include folding or perforation lines to facilitate folding of the strips of material.

11. Binding element according to claim 8, comprising a material capable of being stapled.

12. Binding element according to claim 11, comprising paper or cardboard material.

13. Binding element according to claim 8, wherein the free edge of the bundle of loose leaves is bound by means selected from the group consisting of stapling, cold gluing, hot gluing, punching with plastic and metal rings.

14. End leaf which can be bound together with a bundle of loose leaves by applying a method according to claim 2, said end leaf comprising a strip of glue.

15. End leaf according to claim 14, wherein the strip of glue is provided near and parallel to a free edge of the end leaf.

16. End leaf according to claim 14, comprising a material capable of being stapled.

17. End leaf according to claim 14, comprising a fixing strip on its side edge to be bound which is partly fixed to the end leaf and which is provided with a strip of glue on a part thereof which is not fixed to the end leaf and on the side turned away from the end leaf, provided at a distance from the side edge of the end leaf to be bound.

18. End leaf according to claim 17, wherein the fixing strip is fixed to the end leaf by means of gluing.

19. End leaf according to claim 17, wherein the fixing strip is formed of a folded part of the end leaf.

20. Binding element which can be applied in a method according to claim 1, comprising a strip of material onto which has been provided a strip of glue on at least one side.

21. Binding element according to claim 20, wherein the strip of glue is provided at a distance from a side edge of this strip of material.

22. Binding element according to claim 21, wherein the distance of the strip of glue up to the side edge is equal to or larger than the depth of a U-shaped back of a cover in which the binding element is provided.
